(19) United States
(12) Patent Application Publication
(10) Pub. No.: US 2008/0192582 A1
(43) Pub. Date: Aug. 14, 2008

(54) Timepiece suggestive of orbital motion

(75) Inventors: Frank H. Spoto, East Chatham, NY (US); Robert M. Carangelo, Glastonbury, CT (US); Wayne M. Antonson, East Chathem, NY (US)

Correspondence Address: DAVID LEWIS, 1250 AVIATION AVE., SUITE 200B, SAN JOSE, CA, 95110, US

(73) Assignee: Now is Forever, LLC.

(21) Appl. No.: 12/070,236

(22) Filed: Feb. 14, 2008

Related U.S. Application Data
(60) Provisional application No. 60/901,541, filed on Feb. 14, 2007.

(51) Int. Cl. G04B 19/00; G04C 19/00; G04D 3/00

(52) U.S. Cl. 368/76; 368/82; 29/896.3

(57) ABSTRACT

In an embodiment, the indication of the seconds is in an inner portion of the face of the clock, the indication of the hours is on an outer portion of the face of the clock, and the indication of the minutes is between the hours and the seconds. In an embodiment, the indication of the seconds is performed by placing a leading time indicator of a group of time indicators in a current time state, followed by a tail of time indicators that may have a constant or have a range of mixed states that may range in appearance that is closest to the current time state to a an appearance that is closest to a non-current time state in an order such that the closer in appearance to the current time state the time indicator is, the closer the time indicator is to the current time state.

### CROSS-REFERENCE TO RELATED APPLICATIONS

This application claims priority benefit to U.S. Patent Application No. 60/901,541 (Docket #14-3), filed Feb. 14, 2007, entitled “A Timepiece Suggestive of Orbital Motion”, by Frank H. Spoto, Robert M. Carangelo and Wayne M. Antonson which is incorporated herein by reference. This application is related to U.S. patent application Ser. No. 11/182,620 (Docket #14-1), filed Jul. 5, 2005, entitled “A Time Piece,” by Frank H. Spoto and Robert M. Carangelo which is incorporated herein by reference.

### FIELD

The invention is generally related to timepieces.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Often clocks have a second hand that is long, a minute hand that is shorter, and an hour hand that is yet shorter.

### BRIEF DESCRIPTION OF DRAWINGS

In the following drawings like reference numbers are used to refer to like elements. Although the following figures depict various examples of the invention, the invention is not limited to the examples depicted in the figures.

FIG. 1A shows a representation of an example of a clock according to the invention.

FIG. 1B shows a representation of the side of an embodiment of the clock.

FIG. 1C shows a representation of the bottom of an embodiment of the clock.

FIG. 1D shows a representation of a cross section of the body of an embodiment of the clock.

FIG. 1E shows a representation of another embodiment of the clock.

FIG. 1F shows a representation of another embodiment of the clock.

FIG. 2 shows a block diagram of an example of a circuit for the clock.

FIG. 3 shows a block diagram of another example of a circuit for the clock.

FIG. 4 shows a flowchart of an example of a method of operating an embodiment of the clock.

FIG. 5 shows a flowchart of an example of a method of constructing an embodiment of the clock.

### DETAILED DESCRIPTION OF DRAWINGS

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

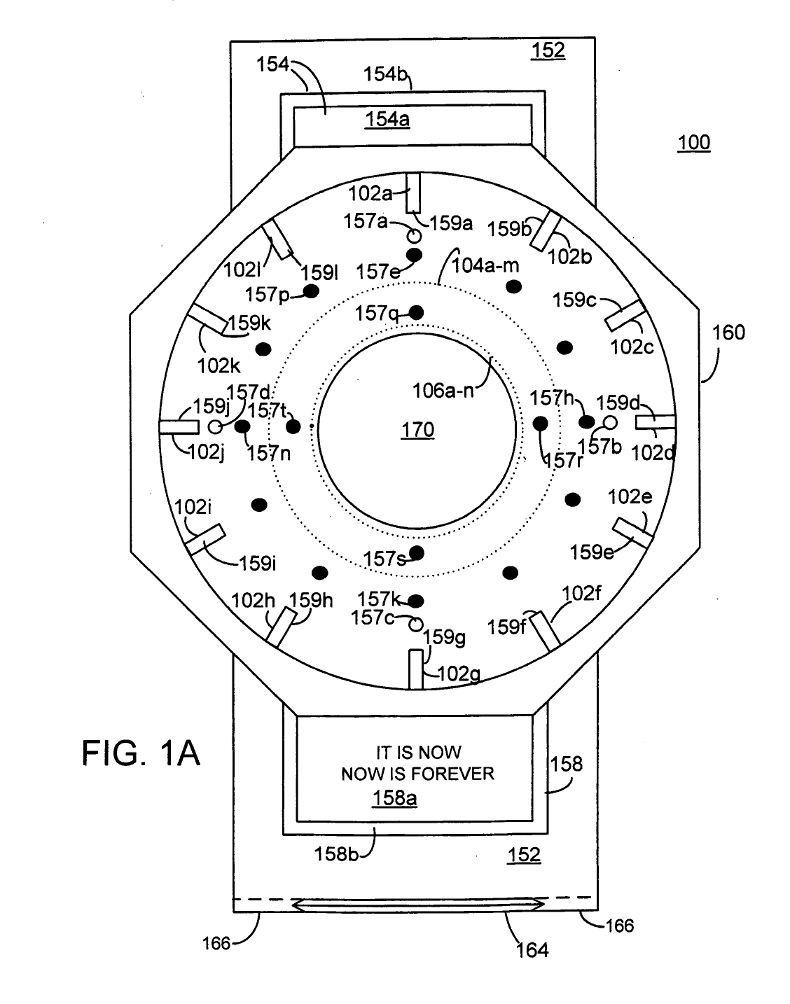

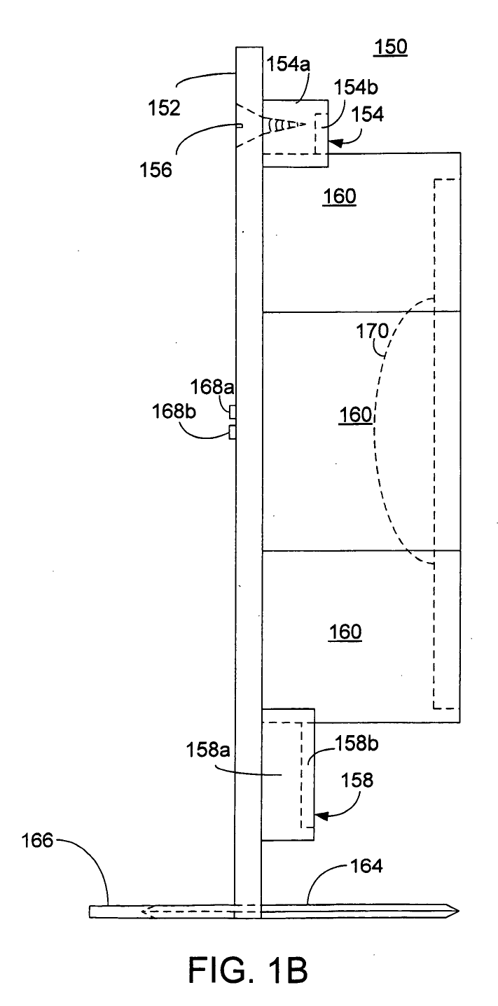

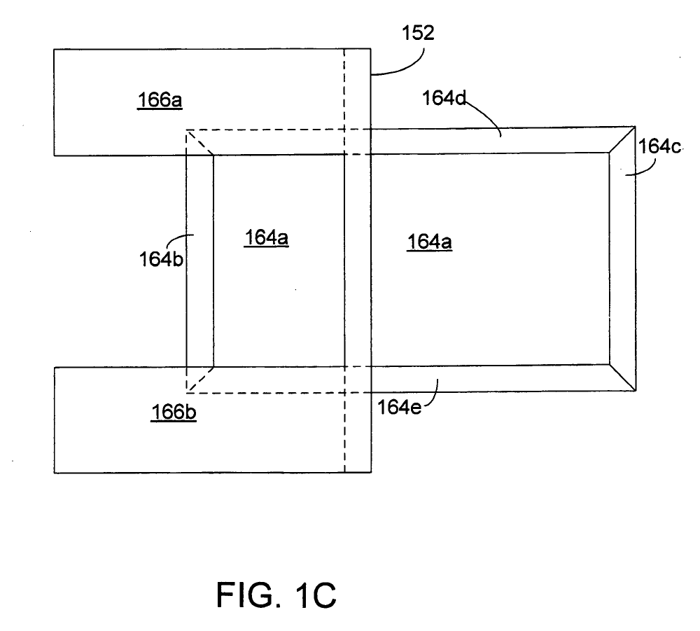

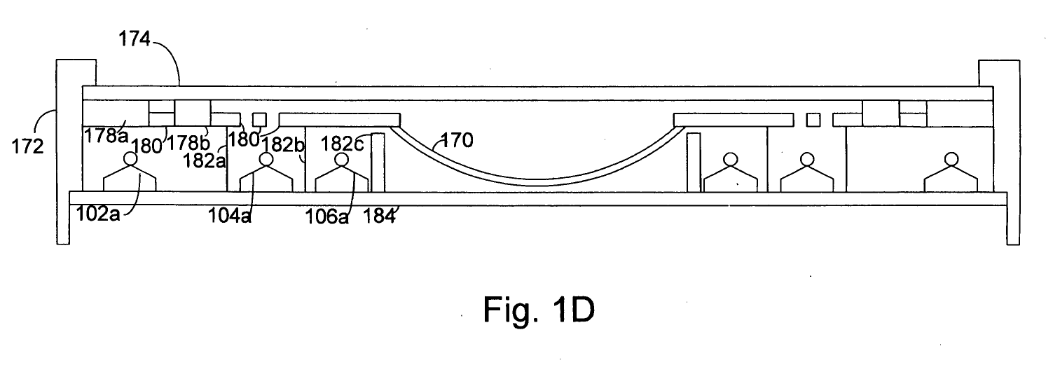

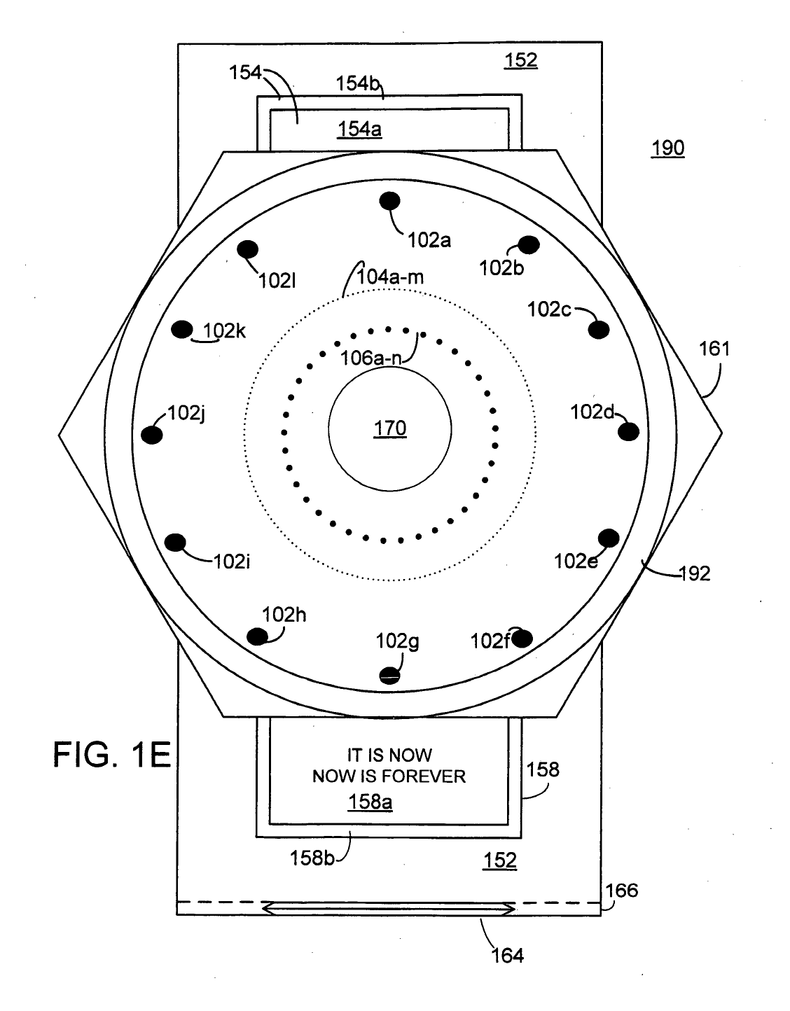

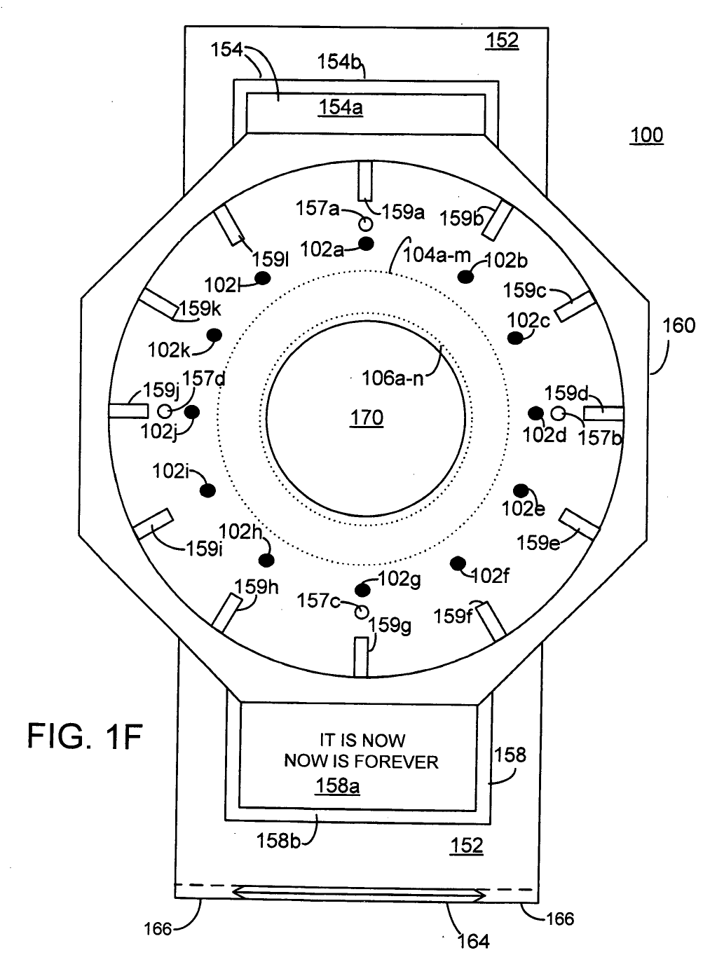

In general, at the beginning of the discussion of each of FIGS. 1A-3 is a brief description of each element, which may have no more than the name of each of the elements in the one of FIGS. 1A-3 that is being discussed. After the brief description of each element, each element is further discussed in numerical order. In general, each of FIGS. 1A-5 is discussed in numerical order and the elements within FIGS. 1A-5 are also usually discussed in numerical order to facilitate easily locating the discussion of a particular element. Nonetheless, there is no one location where all of the information of any element of FIGS. 1A-5 is necessarily located. Unique information about any particular element or any other aspect of any of FIGS. 1A-5 may be found in, or implied by, any part of the specification.

FIG. 1A shows a representation of an example of a clock 100. Clock 100 includes hour-indicators 102a-l, minute-indicators 104a-m, and second-indicators 106a-n. Clock 100 may also include support 152, block 154 (having block body 154a and block rim 154b), markers 157a-l, block 158 (having block body 158a and block rim 158b), ticks 159a-l, clock body 160, sliding base 164, back base 166, and central portion 170. In other embodiments, clock 100 may not have all of the parts listed and/or may have other parts instead of, or in addition to, those listed.

In an embodiment, a minimum of three concentric and coplanar circles on the clock face of clock 100 may describe the placement locus of the indicators that represent hours, minutes, and seconds. In this specification, the positions on the face of clock 100 may be specified using the number of degrees that a time indicator would have traveled in the clockwise direction from the 12 to get to the position in question. Thus, the 12's position is at 0 degrees (and at 360 degrees), the 1's position is at 30 degrees, the 2's position is at 60 degrees, and the 3's position is at 90 degrees, for example. Alternatively, the positions on face of clock 100 may be specified by the hour associated with that position were an hour hand pointing towards that position (e.g., one o'clock, two o'clock, three o'clock, etc.).

In an embodiment, each of hour-indicators 102a-l is located behind a tick that is opaque. Each of hour-indicators 102a-l may have at least two states, which are a current time state that indicates that a given hour-indicator corresponds to the current hour (e.g., the current hour portion of the time of day) and a non-current time state that indicates a given hour-indicator does not correspond to the current hour. Any two visually distinct states may be used for the current time state and the non-current time state. For example, the current time state and non-current time state could be two different colors or could be an activated state and a non-activated state. The activated state may be an on state in which a light is lit (or light is allowed to pass) and the non-activated state may be an off state in which the light is not lit (or light is not allowed to pass). In an embodiment, hour-indicators 102a-l are Light Emitting Diodes (LEDs), and the current time state is the on state. In another embodiment, hour-indicators 102a-l are another type of device. For example, light indicators 102a-l may be another device that emits light, such as a small incandescent light bulbs or may be a device that allows light to pass through, such as a Liquid Crystal Display (LCD) cell that opens to allow ambient light or light from a light bulb to pass through. In another embodiment, each of hour-indicators 102a-l may be a spot on an LCD. In another embodiment, the hour-indicators 102a-l may be reflective, and the two states of the hour-indicators 102a-l may be two states in which different amounts of light are reflected and/or absorbed. In yet another embodiment, the current time state is the off state (instead of an on state).

In an embodiment, the centers of hour-indicators 102a-l form a circle having a radius of 11.2 cm. In other embodiments, the centers of hour-indicators 102a-l form a circle of another size. In an embodiment, there are 12 hour-indicators (e.g., 12 LEDs, one for each hour on a standard clock). In another embodiment, there are more than 12 hour-indicators. In an embodiment, hour indicators 102a-l are rectangular in shape.

In an embodiment, if there are 12 hour-indicators, each of hour-indicators 102a-l is in the current time state from the second that the hour changes to the hour represented by that hour-indicator until the second prior to the next hour. In an embodiment, at any given moment, only one of hour-indicators 102a-l is in a current time state, indicating the hour part of the time, and there are no trailing hour-indicators in any mixed states. For example, hour-indicator 102a may be in the current time state from 12:00 until 12:59 and 59 seconds, hour-indicator 102b may be activated from 1:00 until 1:59 and 59 seconds, and hour-indicator 102c may be activated from 2:00 until 2:59 and 59 seconds. In another example, there may be 24, 36, 48, or 60 hour-indicators, and the position of the hour-indicator corresponding to the current time indicator changes every half hour, third, quarter, or fifth of an hour.

Minute-indicators 104a-m indicate the minutes. Minute-indicators 104a-m may have a current time state, a non-current time state, and multiple mixed states that are each a different state that appears partially between the current time state and the non-current time state. For example, the current time state may be a fully lit state of an LED or a state on another optical element that appears bright, the mixed states may be partially lit or partially bright states (each mixed state having a different brightness), and the non-current time state may be an off state (or a dark state of another type or optical element). In another embodiment, the current time state may be an off state (or another dark state), and the non-current time state may be an on state (or another bright state). In an embodiment, the circle formed by the outer edge of minute-indicators 104a-m has a radius of 7.5 cm. In other embodiments, the circle formed by minute-indicators 104a-m may have another radius. In an embodiment, a given one of minute-indicators 104a-m may start in a non-current time state and may remain in the non-current time state until the minute-indicator corresponds to the current minute. When the given minute-indicator corresponds to the current minute, the minute-indicator is placed in the current time state. All the minutes behind the current time state back to the one minute mark are placed in a mixed state having a perceived intensity that is ½ the perceived intensity of the current state. In this embodiment, the zeroth minute-indicator is only lit once, which is while the zeroth minute is the current minute. While the zeroth minute-indicator is lit, all of the other minute-indicators are lit at an intensity that is perceived as half that of the zeroth minute-indicator. When the time advances, the next minute-indicators is lit as the current minute, and the remainder of the minute-indicators are placed into the noncurrent time state, and the process starts again in which as the current time indicator advances forward up all of the minute-indicators between the current time indicator and the first minute-indicator after the zeroth minute-indicator are placed in a mixed state that has an intensity that appear to be half that of the current minute-indicator. The minute-indicator at the 12 o'clock (or 0 degree) position is only placed into the current time state if it is the leading minute-indicator, and is never placed in a mixed state. If the current time state is an active state, the minute-indicator at the 12 o'clock (or 0 degree) position will only be in the current time state (e.g., activated) when it is the leading minute.

In another embodiment, when the given minute-indicator corresponds to the prior minute, the given minute-indicator is placed in a mixed state that is relatively close in appearance to the current time state (e.g., the minute-indicator corresponding to the prior minute may be the mixed state chosen form a set of mixed states that is closest in appearance to the current time state). When a given minute-indicator corresponds to two minutes ago, the given minute-indicator may be in a mixed state that is either just as close in appearance to the non-current time state or a little closer in appearance to the non-current time state as the minute-indicator that corresponds to the prior minute. Each minute-indicator that is in a mixed state is either just as close in appearance to the non-current time state or closer in appearance to the non-current time state as the minute-indicator adjacent to it in the clockwise direction, and is also either just as close in appearance to the current time state or closer in appearance to the current time state as the minute-indicator adjacent to it in the counterclockwise direction. When the next minute arrives, each minute-indicator that is not in the non-current time state switches to the next mixed state that has the next closest appearance to the current time state. In other words, as each minute passes, any give minute-indicator in a group of minute-indicators that trails the minute-indicator that indicates the current time changes to the next mixed state that is closer in appearance to the non-current time state. For each minute-indicator in that is not in the non-current time state, this process continues until the minute-indicator is place in the non-current time state.

The effect of having a group or minute-indicators in mixed states is that the current minute-indicator appears to have a trailing tail. If the current time state is a fully lit state, the appearance is similar to a comet with a trailing tail. In an embodiment, the minute-indicators that form the tail, if any, will be activated at less than or equal to half the perceived intensity of the leading minute. In an embodiment in which minute-indicators 104a-m are LEDs, obtaining 50% of perceived the intensity means cutting the power to 12%. In an embodiment, the further a location is along the tail away from the head of “comet” the darker that part of the tail (and the darker the corresponding minute-indicator is).

In an embodiment, there may be 60 minute-indicators (e.g., there may be one minute-indicator every six degrees). In another embodiment, there may be more than or less than 60 minute-indicators. For example, there may be only 12 minute-indicators (e.g., in this embodiment not every minute is indicated, but only every fifth minute is indicated) or there may be 120 minute-indicators. In an embodiment, there are 64 minute-indicators. Specifically, there may be one minute-indicator for each minute and an additional minute-indicator that is activated at each quarter of an hour. In another embodiment, there may be 72 minute-indicators. Specifically, there may be one minute-indicator for each minute and an additional minute-indicator that is activated at each five minute marking. In an embodiment having minute-indicators at each five minute marking and/or at each fifteen minute marking, the minute-indicator indicating a passage of five minutes or a passage of fifteen minute, respectively, has the same state as the adjacent minute-indicator in the circle of minute-indicators. In an embodiment, the centers of the five minute or fifteen minute marking lie on a circle having a radius of 8.2 cm. The additional minute-indicators (that mark the passage of fifteen minutes) will be discussed further in conjunction with markings 157e-h. Similarly, second-indicators 106a-n indicate the seconds, and may also have a current time state, a non-current time state, and multiple mixed states, where the multiple mixed states are each a different state that is partially between the current time state and the non-current time state. Second-indicators may be used to indicate something similar to seconds in that the leading second-indicator will traverse around its circle 5 times per minute. Thus the second-indicator at the 12 o'clock position may be activated at 0, 12, 24, 36, & 48 seconds into each minute. In another embodiment, each second-indicator indicates the passage of only one second and the leading second-indicator traverses around its circle only once per minute. In other words, second-indicators 106a-n may be configured to produce the appearance of a comet or ball of light with a decaying tail circling at 1 RPM or 5 RPM. For simplicity, the embodiment in which each second-indicator corresponds one second is discussed first.

In an embodiment, each of second-indicators 106a-n may be in a non-current time state up until that second-indicator corresponds to the current second. When the second-indicator corresponds to the prior second, the second-indicator may be placed in a mixed state that is relatively close in appearance to the current time state (e.g., the mixed state chosen form a set of mixed states that is closest in appearance to the current time state). When the next second arrives, each of a group of second-indicators that is not in the non-current time state switches to the next mixed state that has the next closest appearance to the non-current time state. As each second passes, each of the second-indicators that is not already in the non-current time state changes to the next mixed state. This process is repeated for each second-indicator that is not in the non-current time state until the second-indicator is placed in a non-current time state.

In another embodiment, each of second-indicators 106a-n may be in a non-current time state up until that second-indicator corresponds to the current fifth of a second. When the second-indicator corresponds to the prior fifth of a second, the second-indicator may be placed in a mixed state that is relatively close in appearance to the current time state (e.g., the mixed state chosen form a set of mixed states that is closest in appearance to the current time state). When the next fifth of a second arrives, the second-indicator switches to the next mixed state that has the next closest appearance to the current time state. As each fifth of a second passes, the second-indicator changes to the next mixed state until the second-indicator is placed in a non-current time state.

In an embodiment in which the current time state is an active state, several of second-indicators 108a-n immediately behind the leading second-indicator (the second-indicator that is in the current time state) may be activated such that each indicator is 75% to 80% the perceived intensity of the indicator in front of it. The effect is something similar to that of a comet circling the sun with its decaying tail trailing behind. In an embodiment, the perceived intensity may gradually decay and approach 75% to 80% at the end of every 6°, and the length of the tail may extend over a 60° to 90° range. In an embodiment, if there are only 60 to 64 second-indicators, then each second-indicator in the tail may have an intensity that is 75% to 80% of the preceding second-indicator, but if there are more than 64 second-indicators, the perceived intensity may gradually decay and approach 75% to 80% at the end of every 60. For an LED, 80% of perceived intensity requires reducing the power used for lighting the LED by half.

Thus, time indicators (e.g., LEDs) may be arranged in concentric circles. However, the seconds are located on an inner circle while the hours are located on the outer circle. Minute-indicators 104a-m advance one time-indicator every minute leaving the previous minutes, back to 0, dimly illuminated behind it. The patterns for the seconds and the minutes may be symbolic of time being but a decaying memory of the past (represented by the decaying tail). The hour-indicators anchor the viewer firmly in the present by being illuminated one at a time. In an embodiment, the clock's appearance is related to planets of the solar system. Specifically, the ratio of the radii may be the same as ration of the average radii of three planets orbiting the Sun (e.g., Venus, Earth, and Mars or other planets).

In an embodiment, appearance of the clock is related to the Fibonacci series, which is a series of numbers such that each number in the series is the sum of the two prior numbers of the series, and the first two numbers in the series are both 1. Thus, the Fibonacci series is 0, 1, 1, 2, 3, 5, 8, . . . , and the radius of the ring containing hour-indicators 102a-l may be the fourth or higher Fibonacci number of may be the fifth or higher Fibonacci number. For example, the radius of hour-indicators 102a-l may be three times the radius of second-indicators 106a-n, and the radius of minute-indicators 104a-m may be twice the radius of the second-indicators 106a-n. As other examples, the ratio of the radius of hour-indicators 102a-l to the radius of second-indicators 106a-n may 5/2, 8/3, or 13/5, and the radius of ration of the radius of minute-indicators 104a-m to the radius of second-indicators 106a-n may be 3/2, 5/3, or 8/5, respectively. The optical and other considerations associated with hour-indicators.102a-l, minute-indicators 104a-m, and second-indicators 106a-n are discussed below in conjunction with FIG. 1D.

Markers 157a-d may mark every three hours, and may be made from onyx. Markers 157a-d are optional. In an embodiment, the centers of markers 157a-d lie in a circle having a radius 8.9cm. The material used for markers 157a-d will be discussed below in conjunction with ticks 159a-l.

Markers 157e-t may be time indicators, such as LEDs, and markers 157e-t may be made from the same materials as hour-indicators 102a-l, minute-indicators 104a-m, and/or second-indicators 106a-n. Markers 157e-p may be used to aid in identifying the passage of 5 minutes or a specified number of seconds. Markers 157e-p may be placed every 30 degrees. Each of markers 157e-p may mark a passage of 5 minutes. In an alternative embodiment, there may be 4 markers 157e-p, one every 90 degrees starting at 0 degrees, each marking the passage of 15 minutes.

Regarding markers 157q-t, if the comet (formed by an arc of second-indicators 106a-n) revolves at a rate of one revolution per minute, then each of markers 157q-t may mark a passage of 15 seconds. If the comet revolves at 5 revolutions per minute, then each of markers 157q-t may mark the passage of 3 seconds. In an alternative embodiment, there may be 12 markers 157q-t, one every 30 degrees starting at zero degree. Although minute-indicators 104a-m, second-indicators 106a-n and markers 157a-t are dots in the embodiment of FIG. 1A other shapes may be used instead, such as squares, triangles, or hexagons. Although minute-indicators 104a-m, second-indicators 106a-n and markers 157a-t are illustrated as being of different sizes in FIG. 1A hour-indicators 102a-l, minute-indicators 104a-m, second-indicators 106a-n and markers 157a-t may all be the same size. Alternatively, hour-indicators 102a-l, minute-indicators 104a-m, second-indicators 106a-n and markers 157a-t may be of different sized, but may nonetheless have different relative sizes than those illustrated in FIG. 1A.

If there are 12 ticks, ticks 159a-l mark the hours and help identify hour-indicators 102a-l. In an embodiment hour-indicators 102a-l are located behind ticks 159a-l, and light emitted from hour-indicators 102a-l illuminates the sides of ticks 159a-l. In an embodiment, ticks 159a-l may be rectangular and may be made from onyx for decorative purposes. However, in other embodiments, ticks 159a-l may be made from other materials, but have an onyx coloring. Markers 157a-d may be made from the same material as ticks 159a-d or may be made from a different material. In another embodiment, ticks 159a-l may be made from other materials and/or may have other colorings. In another embodiment, ticks 159a-l may have a different shape. In another embodiment, there may be 12 ticks or another number of ticks, and/or ticks 159a-l may not be present. For example, there may be only 4 ticks. Alternatively, there may be 12 ticks of a larger size and another 48 ticks of a smaller size, with 4 smaller ticks between each two of the larger ticks. In an embodiment, the number of hour-indicators may correspond to the number of ticks that mark hours. In another embodiment, there may be some hour-indicators without any tick in front and some hour-indicators that have a tick in front. For example, there may be 4 ticks, each three hours apart, and there may be 12 hour-indicators

Support 152, block 154, block body 154a, block rim 154b, block 158, block body 158a, block rim 158b, clock body 160, sliding base 164, back base 166, and central portion 170 are discussed in conjunction with FIGS. 1B and 1C, below. Clock 100 may display and thereby convey one or more philosophical messages, such as, “IT IS NOW” and/or “NOW IS FOREVER.” These two particular philosophical messages may remind the viewer of the significance of the moment and provide a perspective on life. Although in the embodiment of FIG. 1A the philosophical message appears on block 158, additionally or alternatively, the one or more philosophical messages may appear on block body 158a of block 158, the philosophical message may appear elsewhere, such as on support 152, block 154, sliding base 164, back base 166, and/or central portion 170.

FIG. 1B shows an example of the side 150 of clock 100. Side 150 includes support 152, block 154 (having block body 154a and block rim 154b), screw 156, block 158 (having block body 158a and block rim 158b), clock body 160, sliding base 164, back base 166, and central portion 170. In other embodiments, side 150 may not have all of the parts listed and/or may have other parts instead of, or in addition to, those listed.

The recesses and parts of FIG. 1B or in any other FIG. that are hidden from view by other parts are shown using dashed lines. Support 152 supports the body of clock 100. Block 154 may help hold clock 100 to support 152 (in addition to having a decorative shape and front face). Block 154 may have block body 154a, which is the main body of block 154a, and may have block rim 154b, which is a rim on block 154. Block rim 154b may be seen more clearly in FIG. 1A, and may be a decorative feature. Screw 156 holds block 154 to support 152. In another embodiment, a nail, bolt, bracket, and/or adhesive may be used in addition to or instead of screw 156. Although only one screw is shown, there may be several screws, nails, bolts, spots having an adhesive applied, and/or brackets holding block 154 to support 152 and/or holding other parts of clock 100 together.

Block 158 may also help hold clock 100 to support 152. Similar to block 154, block 158 may have block body 158a, which is the main body of block 158, and block rim 158b, which is a rim on block 158. Blocks 154 and 158 may extend under clock body 160, and help hold a bottom of clock body 160 in place (e.g., blocks 154 and 158 may hold a circuit board in place). Block rim 158b may be seen more clearly in FIG. 1A, and may be a decorative feature.

Clock body 160 is the body of clock 100 that is held to support 152 optionally with the aid of block 154 and 158. Clock body 160 may contain the components that make up the interior of the clock 100. Although in FIG. 1A, clock body 160 is depicted as octagonal, in other embodiments clock body 160 may have any other shape, such as circular, triangular, square shaped, rectangular, hexagonal, or star shaped.

Sliding base 164 and back base 166 may hold support 152 in an upright position. When sitting on a table or desk, sliding base 164 extends forward thereby preventing clock 100 from falling forward. When mounted on a wall or on a ceiling, back base 166 may be used as a bracket to attach clock 100 to the wall or the ceiling, and in an embodiment sliding base 164 may be removed, extended to the extended position, placed in the back position next to back base 166 in a fully extended backward position, or placed in any position between the fully extended forward position or fully extended backward position.

Push buttons 168a and 168b on support 152 protruding out of the back allow the user to set the time by resetting clock 100 or advancing clock 100 at various rates. In an embodiment, push button 168a may be for setting the hours and push button 168b may be for setting the minutes. In another embodiment, other buttons may be provided. For example, there may be one button for incrementing the minutes, one button for decrementing the minutes, one button for incrementing the hours, one button for decrementing the hours. There may be different buttons for incrementing and/or decrementing the hours and/or minutes at different speeds. There may be other buttons for setting other functions. For example, there may be buttons for setting, turning on, and/or turning off an alarm. In an embodiment, clock 100 may include a radio and there may be buttons and/or other controls associated with the radio. In another embodiment, instead of, or in addition to, push buttons 168a and 168b, switches and/or rotating knobs may be used may be used, and/or there may be a variety of other output buttons. Central portion 170 is optional and is decorative in nature. In an embodiment, central portion 170 may be a central portion of clock 100. Central portion 170 may be transparent, translucent, or opaque. In an embodiment, the edge of central portion 170 touches, or is close to, the edges of second-indicators 106a-n. In an embodiment, the cutout in which central portion 170 fits has a radius of 4.5 cm. In other embodiments, the cutout and central portion 170 may have other sizes. In an embodiment central portion 170 is flat on the side of the viewer and concave on the inside, thus the concave surface faces towards the viewer. For example, central portion 170 may be a plano-concave lens. In another embodiment, instead of central portion 170 being concave, a flat portion and/or a portion that is transparent, translucent, or opaque may be used. Alternatively, hour-indicator 102a-l, minute-indicators 104a-m, and second-indicators 106a-n are located on a circular piece that is made from one flat piece of material that does not have a region in the center that is cutout.

FIG. 1C shows a representation of an embodiment of the bottom 163 of clock 100, having main portion 164a, back edge portion 164b, front edge portion 164c, side edge portion 164d, side edge portion 164e, tab 166a, and tab 166b. In other embodiments, the bottom of clock 100 may not have all of the parts listed and/or may have other parts instead of, or in addition to, those listed.

Main portion 164a is the main portion of sliding base 164, which was described in conjunction with FIG. 1B. Continuing with the description of FIG. 1C, back edge portion 164b and front edge portion 164c are decorative portions of sliding base 164, and are optional. Back edge portion 164b and front edge portion 164c may come to a point having a slanted top and slanted bottom part that meet to form the point or wedge shape. The magnitude of the angle that the top slant makes with the top surface of sliding base 164 and that the bottom slant makes with the bottom surface of sliding base 164 may be the same (but may have opposites signs of direction) or may not be different. In the embodiment of FIG. 1C, side edge portion 164d and side edge portion 164e have the same shape as front edge portion 164a and back edge portion 164b (although in FIG. 1A side edge portion 164d and side edge portion 164e are not labeled edge portion 164d and side portion are shown). Side edge portions 164d and 164e engage and/or fit into grooves in tabs 166a and 166b so that sliding base 164 is held by tabs 166a and 166b in manner that allows sliding base 164 to slide. Although the shape of side edges 164d and 164e have a function, there are many other shapes that would allow sliding portion 164 to slide within grooves in tabs 166a and 166b, which could be used for side edges 164d and 164e. For example, the side edges of sliding portion 164 could rounded or could be flat with two elongated flanges (one for each side) extending along the length of the sides of sliding base 164 to engage tabs 164d and 164e. The edges of the flanges may have rectangular cross sections, rounded cross section, triangular cross sections, or wedge shaped. The precise shape may be chosen based on decorative and/or other considerations.

Tabs 166a and 166b form back base 166, which was described above in conjunction with FIG. 1B. Tabs 166a and 166b have grooves that allow side edge portions 164d and 164e to slide without so much friction that the side edges 164d and 164e get stuck frequently. For example, the groove may have a shape that is complementary to the shape of side edge portions 164d and 164e, creating a void with the same shape as side edge portions 164d and 164e, but slightly larger so that side edge portions 164a and 164b can slide, but not too much larger so that sliding portion 164 does is not likely to become crooked.

In an embodiment, when clock 100 is mounted to a wall, an adhesive may be applied to the bottom surfaces of tabs 166a and 166b. In another embodiment, holes for screws, nails, rivets, and/or bolts may be provided within tabs 166a and 166b. In another embodiment, brackets and/or tape may be secured over the top of tabs 166a and 166b to hold tabs 166a and 166b to the wall or ceiling.

FIG. 1D shows a representation of a cross section of an embodiment of clock body 160 (shown in FIG. 1B). FIG. 1D shows hour-indicator 102a, minute-indicator 104a, second-indicator 106a, central portion 170, frame 172, transparent cover 174, tick 178a, marker 178b, light diffuser 180, partition 182a, partition 182b, partition 182c, and circuit board 184. In other embodiments, clock 100 may not have all of the parts listed and/or may have other parts instead of, or in addition to, those listed.

Hour-indicator 102a, minute-indicator 104a, and second-indicator 106a are included within hour-indicators 102a-l, minute-indicators 104a-m, and second-indicators 106a-n, which were discussed in conjunction with FIG. 1A. Any combination of hour-indicators 104a-l, minute-indicators 106a-m and second-indicators 108a-n (which may be LEDs) may be viewed directly or indirectly by reflection, refraction, scattering or some combination of these effects. Central portion 170 was discussed in FIG. 1B and is shown in FIGS. 1A and 1B. Frame 172 forms the outer wall of clock body 160, which forms a frame on which interior parts of the clock can be mounted. In an embodiment the inner radius at the top of frame 172 is 12 cm. In other embodiments, frame 172 has other dimensions.

Transparent cover 174 protects the interior of clock 100 while allowing the time to be seen. In an embodiment, the radius of transparent cover 174 and of a corresponding portion of frame 172 is 12.3 cm. In other embodiments, transparent covers and frames that have other sizes may be used. In an embodiment, hour-indicators 102a-l, minute-indicators 104a-m, and second-indicators 106a-n may be situated behind a translucent piece of material.

Tick 178a may be one of ticks 159a-l, which were discussed in conjunction with FIG. 1A. Marker 178b may be one of markers 157a-d, which were discussed in conjunction with FIG. 1A. Diffuser 180 scatters light. If hour-indicator 102a-l, minute-indicator 104a-m, and second-indicator 106a-n are sources of light, diffuser 180 diffuses light emitted by hour-indicator 102a-l, minute-indicator 104a-m, and second-indicator 106a-n thereby illuminating diffuser 180 in a relatively uniform manner. In an embodiment, diffuser 180 is a frosted piece of glass or plastic.

Partitions 182a-c separate the light from one time indicator from the light of an adjacent time indicator. Partitions 182a-c prevent and/or limit the light from one-time indicator from illuminating portions or at least from illuminating a significant portion of the diffuser over an adjacent time indicator. Although partitions 182a and 182b are illustrated as having a different thickness than partition 182c, partitions 182a-c may all have the same thickness or may have different thicknesses. Partition 182c, may be thinner than one or both of partitions 182a and 182b. Although in the embodiment of FIG. 1D there is a gap between partition 182c and diffuser 180, while there is no gap between diffuser 180 and partitions 182a and 182b, in other embodiments, there may be no gap between any of partitions 182a-c and diffuser 180, there may be a gap between partitions 182a and/or 182b in addition to or instead of there being a gap between partition 182c and diffuser 180.

Circuit board 184 supports and communicatively couples the electronic components of the clock 100. In an embodiment, circuit board 184 and a corresponding section of frame 174 (into which circuit board 184 fits) has a radius of 12.6 cm. In other embodiments, circuit board 184 and frame 174 have other dimensions.

FIG. 1E shows a representation of clock 190, which is another embodiment of the clock 100. Clock 190 includes hour-indicators 102a-l, minute-indicators 104a-m, and second-indicators 106a-n. Clock 100 may also include support 152, block 154 (having block body 154a and block rim 154b), screw 156, block 158 (having block body 158a and block rim 158b), clock body 161, clock rim 192, sliding base 164, back base 166, and central portion 170. In other embodiments, clock 100 may not have all of the parts listed and/or may have other parts instead of, or in addition to, those listed.

Hour-indicators 102a-l, minute-indicators 104a-m, and second-indicators 106a-n support 152, block 154 (having block body 154a and block rim 154b), screw 156, block 158 (having block body 158a and block rim 158b), clock rim 192, sliding base 164, back base 166, and central portion 170 were discussed above in conjunction with FIG. 1A. Clock 190 differs from clock 100 in that clock 190 does not have markers 157a-d or ticks 159a-l. Also, clock 190 has clock body 161, which is hexagonal, instead of clock body 160, which is octagonal. Additionally, clock body 161 has a rim that is absent from the embodiment of clock body 160 shown in FIG. 1A.

Clock body 161 may optionally have a clock rim 192. Clock rim 192 may aid in preventing glare from obscuring the face of clock 100. Certain shapes for clock rim 192 may be chosen for better protection against glare, such as by extending the height of the clock rim 192 in regions that are expected to block the direction from which a light is expected to shine on clock 100. However, the shape of clock rim 192 may be chosen primarily based on decorative considerations. Also, for indoor use, where glare is not usually a major concern, the shape of clock rim 192 may be chosen entirely on decorative considerations. Although in FIG. 1E, clock rim 192 is depicted as circular, in another embodiment, clock rim 192 may have any shape, such as hexagonal, square, triangular, octagonal. In an embodiment, clock rim 192 has a shape and size such that clock rim 192 fits between the edges of the portion of clock body 161 that surrounds the face of clock 100 without obscuring the face of clock 100. Although in FIG. 1E, clock rim 192 and clock body 161 have different shapes, in an embodiment, clock rim 192 and clock body 192 have the same shape. Optionally, clock rim 192 may also be included in the embodiment of clock 100 shown in FIG. 1A.

FIG. 1F shows a representation of another example of a clock 100. Clock 100 includes hour-indicators 102a-l, minute-indicators 104a-m, and second-indicators 106a-n. Clock 100 may also include support 152, block 154 (having block body 154a and block rim 154b), markers 157a-d, block 158 (having block body 158a and block rim 158b), ticks 159a-l, clock body 160, sliding base 164, back base 166, and central portion 170. In other embodiments, clock 100 may not have all of the parts listed and/or may have other parts instead of, or in addition to, those listed.

Hour-indicators 102a-l, minute-indicators 104a-m, second-indicators 106a-n, support 152, block 154 (having block body 154a and block rim 154b), markers 157a-d, block 158 (having block body 158a and block rim 158b), ticks 159a-l, clock body 160, sliding base 164, back base 166, and central portion 170 were discussed above in conjunction with FIG. 1A. The embodiment of FIG. 1F differs from that of FIG. 1A in that hour indicators 102a-l are circular instead of rectangular and are not covered by ticks, also markers 157e-t are not included in the embodiment of FIG. 1F, but are included in the embodiment of FIG. 1A. Additionally, in FIG. 1F, clock body 160 is hexagonal instead of octagonal.

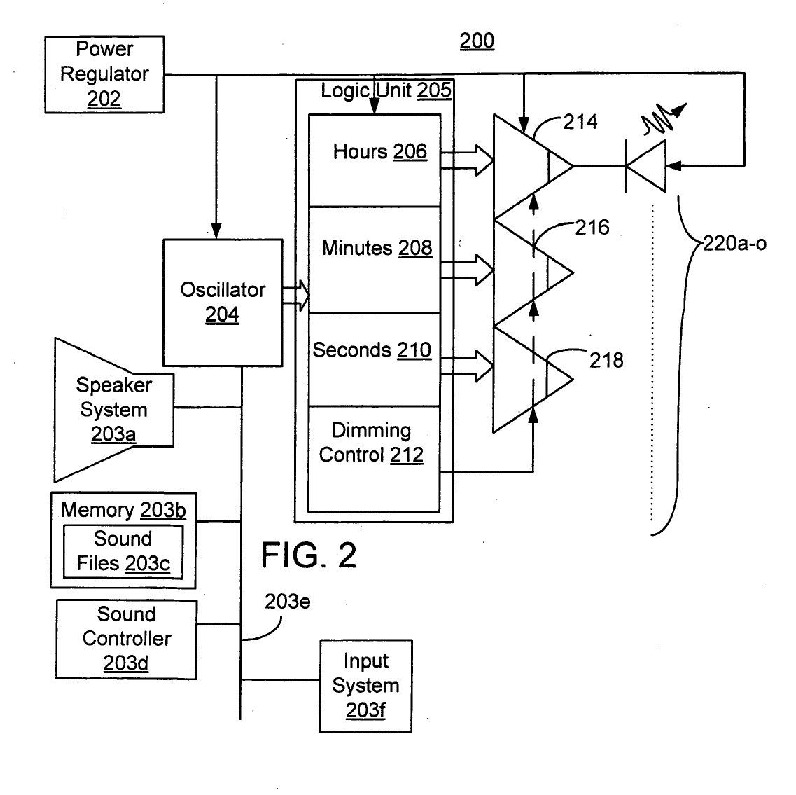

FIG. 2 shows a block diagram of an example of a circuit 200. Circuit 200 includes power regulator 202, speaker system 203a, memory system 203b, sound files 203c, sound controller 203d, communications bus 203e, oscillator 204, logic unit 205, hour controller 206, minute controller 208, second controller 210, dimming control 212, hour driver 214, minute driver 216, second driver 218, time indicators 220a-o. In other embodiments, circuit 200 may not have all of the parts listed and/or may have other parts instead of, or in addition to, those listed.

Circuit 200 controls hour-indicators 102a-l, minute-indicators 104a-m, and second-indicators 106a-n. In an embodiment, a clock 100 uses hour-indicators 102a-l, minute-indicators 104a-m, and second-indicators 106a-n to indicate the time, which may be driven by programmable components that keep track of time. Circuit 200 may allow a user to set the time, and/or allow a user to control sounds played by one or more onboard speakers.

Power regulator 202 provides power to the rest of circuit 200. Speaker system 203a produces sounds associated with the clock 100, such as chimes, a periodic announcement of the time, music unrelated to the time, an alarm, and/or a radio station, for example. Power regulator 202 may take the unregulated voltage supplied by an AC wall transformer or a battery and convert the unregulated voltage to fixed voltages as required by various parts of circuit 200. For example, power regulator 202 may supply 5V to the time indicators, which may be LEDs and 3.3V to the timing, logic and drivers of the time indicators.

Speaker system 203a may play chimes, other sounds associated with the time, and/or sounds unrelated to the time.

Speaker system 203a may include one or more speakers and may be located on circuit board 184 (FIG. 1D). Speaker system 203a may be limited in size as a result of being coupled to circuit board 184 and the limited space within clock body 160.

Memory system 203b may include one or more storage devices each including one or more machine-readable media. The term machine-readable medium is used to refer to any medium capable of carrying information that is readable by a machine. One example of a machine-readable medium is a computer-readable medium, such as a floppy disc, flash memory, random access memory, or compact disc. Another example of a machine-readable medium is paper having holes that are detected that trigger different mechanical, electrical, and/or logic responses. The term machine-readable medium also includes media that carry information while the information that is in transit from one location to another, such as copper wire and/or optical fiber.

Memory system 203b may store sound files 203c. Sounds that chime out the hours may be produced by sequencing through sound files 203c stored in memory system 203b, and the data in sound files 203c may be used to drive speaker system 203a. Sound controller 203d may convert portions of sound files 203c into signals that drive speaker system 203a. In one embodiment, the hours are linked to sounds corresponding to the 12 unique half tones of the musical scale.

Bus 203e allows controller 203d to access sound files 203c in memory system 203b and to send signals to speaker system 203a based on sound files 203c (the choice of which files or which portions of files from sound files 203c are selected may depend upon signals extracted from oscillator 204).

Oscillator 204 generates a timing signal that may be an oscillating signal having a precise period. Oscillator 204 may oscillate with a constant frequency that is high enough and has enough accuracy to be used for reliably determining the time (e.g. not losing more than a few seconds per year). The exact frequency of the oscillation is not important as long as the relation between the number of oscillations and a particular unit of time (e.g., a second) is known accurately. Oscillator 204 may be connected to programmable components to count seconds, minutes, and hours. The programmable components may be Programmable Logic Devices (PLDs), but could be any number of types of circuits. The PLDs may also control the relative power sent to hour-indicators 102a-l, minute-indicators 104a-m, and second-indicators 106a-n (including the power for the decaying tails of the seconds and minutes) by switching minute-indicators 104a-m and second-indicators 106a-n between two states (e.g., by turning LEDs on and off) at a high enough frequency and varying the duty cycle to create different mixed states that have appearances that are between the current time state and the non-current time state. The timing of when certain sounds are produced by speaker system 203a may be timed by oscillator 204. Alternatively, the mixed states may not only appear to be different states, but be different states. For example, if the current time state is a light being on and the non-current state is the light being off, the mixed state may be different amounts of dimness. Oscillator 204 may be an electronic oscillator that produces a very consistent high frequency square wave that the rest of the circuit 200 divides down to get hours, minutes and seconds. In an embodiment in which the timing indicators are LEDs, although mixed states of the time indicators may be produced in other ways, the dimming control may use the timing signal produced by oscillator 204 to modulate the pulse width of the signal sent to the time indicators and thereby control how much power, and hence brightness, is output from the LEDs. In an embodiment, the oscillator frequency is 14.7456 MHz which is exactly 2¹⁶×3²×5²×1 Hz, a number easily dividable by digital logic to get intervals of seconds. The accuracy of this standard will determine the overall accuracy of the clock over time. For example, a 3 ppm accuracy oscillator may result in an 8 seconds drift per month.

Logic unit 205 includes hour controller 206, minute controller 208, second controller 210, and dimming control 212. Logic unit 205 may include divider circuitry and dimming control. The divider circuitry of logic unit 205 counts out seconds, minutes, and hours based on the oscillation frequency of oscillator 204. Based on the seconds minutes and hours that were counted out a determination is made as to which time indicator (e.g., LED) or set of time indicators (e.g., set of LEDs) to activate (e.g., illuminate) while the dimming control sets the appropriate power level to every time indicator (e.g., to every illuminated LED).

Hour controller 206 is the part of logic unit 205 that counts out the hours and determines which time indicator to activate so as to indicate the current hour. Hour controller 206 responds to oscillator 204 to determine which hour-indicator is placed in the current time state. Similarly, minute controller 208 is the part of logic unit 205 that counts out the minutes and determines which time indicators to activate so as to indicate the current minute. Minute controller 208 responds to oscillator 204 to determine which minute-indicator is placed in the current time state and which minute-indicators are placed in each mixed state (in an embodiment only one minute-indicator is in the current time state at any given time, while at any given moment multiple minute-indicators are in mixed states). Also, second controller 210 is the part of logic unit 205 that counts out the seconds and determines which time indicators to activate so as to indicate the current second. Second controller 210 responds to oscillator 204 to determine which second-indicator is placed in the current time state and which second-indicators are placed in each mixed state.

After counting a certain number of oscillations, second controller 210 increments which of second-indicators 106a-n is in the current time state. Similarly, after counting another number of oscillations (which may be 60 times the count that is counted for incrementing the seconds) which minute-indicator is in the current time state is incremented to the next minute, and after counting another number of oscillations that is 60 times the count for minutes which hour-indicator is in the current time state is incremented to the next hour-indicator. One PLD may form the combination of hour controller 206, minute controller 208, and/or second controller 210. In another embodiment, each of hour controller 206, minute controller 208, and/or second controller 210 may each include one or more PLDs. In an embodiment, since hour-indicators 102a-l are behind the hour markers 159a-l, hour-indicators 102a-l appear dim to compensate the remaining time indicators are dimmed so that the other time indicators appear to have the same brightness as hour-indicators 102a-l when both are in the current time state.

Dimming control 212 may dim the LEDs and/or other light sources for obtaining a lower level of illumination. Dimming control 212 may dim any lights used to illuminate hour-indicators 102a-l, minute-indicators 104a-m, and/or second-indicators 106a-n during periods in which low lighting is desired. The overall illumination level of the clock can be controlled either in an analog fashion by (if the time indicators emit light) throttling the voltage being supplied to hour-indicators 102a-l, minute-indicators 104a-m, second-indicators 106a-n, and any other indicators in a digital fashion by adding in another frequency of varying duty cycle to the LED drive. In an embodiment, photosensors monitor ambient light level to automatically dim the lighting of clock 100 in low light conditions.

For example, there may be one intensity of illumination during the daytime and a lower level of intensity of illumination during the nighttime. There may be a daytime mode. During the day time mode, if the current time states are active states, the daytime mode may be the brightest mode for the clock having the current time indicators at their brightest possible settings and all mixed state time indicators may be at 75% to 80% of this perceived intensity. There may be a nighttime mode, which may be the dimmest mode for the clock. During the night time mode, the intensity of the indicators may be reduced by between 5% to 40% of their perceived daytime intensity. For active indicators, such as LEDs, the power sent to the indicators may be reduced. If passive optical elements are used as time-indicators, reducing the intensity towards evening (while still keeping the time-indicators visible) may mean having to supply a background light as the indicators will naturally dim with the ambient light, or for time indicators formed from passive optical elements that rely on a background light supply even during the daytime, the background light supply may be dimmed. The shifts from the daytime mode to the nighttime mode and back may occur over selected time intervals (e.g. over a couple of hours in the morning and/or over a couple of hours in the evening, respectively) at a gradual rate so as not to make the change too abrupt.

Hour driver 214 drive hour-indicators 102a-l, minute driver 216 drive minute-indicators 104a-m, and second driver 218 drive second-indicators 106a-n. Hour driver 214, minute driver 216, and second driver 218 may include amplifiers. Hour driver 214 may amplify the signal produced by hour controller 206, minute driver 216 may amplify the signal from minute controller 208, and second driver 218 may amplify the signal from second controller 210. The signal from minute driver 216 may be divided among several minute-indicators or there may be several minute drivers to create the trailing tail of minute-indicators. Similarly, the signal from second driver 218 may be divided among several second-indicators or there may be several second drivers to create the trailing tail of second-indicators.

Hour driver 214, minute driver 216, and second driver 218 may throttle the power to the time indicators (e.g., to the LEDs). In some embodiments, hour driver 214, minute driver 216, and/or second driver 218 may be a set of transistors (e.g., one for each LED) or other components that is equivalent to transistors controlling the current through the time indicators (e.g., through the LEDs). If LEDs are used for the time indicators and transistors are used for hour driver 214, minute driver 216, and second driver 218, the transistors may be open drain field effect transistors (FETs) (e.g., one for each LED) that turn the current to the LEDs on or off. Brightness in this embodiment may be controlled by pulse width modulation, which may include pulsing the current on with a varying duty cycle. As long as the pulsing is faster than about 60 Hz, the human eye usually does not see fluctuations due to turning the time indicators on and off. Although FIG. 2 only shows three drivers there may be anywhere between 132 and 212 drivers, for example, and the drivers may be incorporated in the output drivers of the PLDs (e.g., Altera PLDs). Each driver may be driven by the dimming logic, such as dimming control 212 (as noted by the dashed arrows), which may be used to generate an intricate patterns on the clock face. If the indicators are LEDs, dimmer control 212 may raise and lower the brightness of all the LEDs from daytime to nighttime in addition to also setting multiple LEDs in the minutes and seconds to several brightness levels.

Time indicators 220a-o represent the combination of hour-indicators 102a-l, minute-indicators 104a-m, and second-indicators 106a-n. In an embodiment, each of time indicators 220a-o is in series with one of a set of resistors. The values of the resistors are chosen so that each of the time indicators 220a-o receives a current and a voltage drop that is appropriate for proper operation. For example, if time indicators 220a-o are LEDs, the values of the resistors may depend on the color of the LEDs, because different color LEDs have different voltage and current requirements.

Circuit 200 may be coupled (e.g., attached) to one or more circuit boards that mounts into the back of the clock with time indicators 220a-o facing forward and shining through a decorative machined plate.

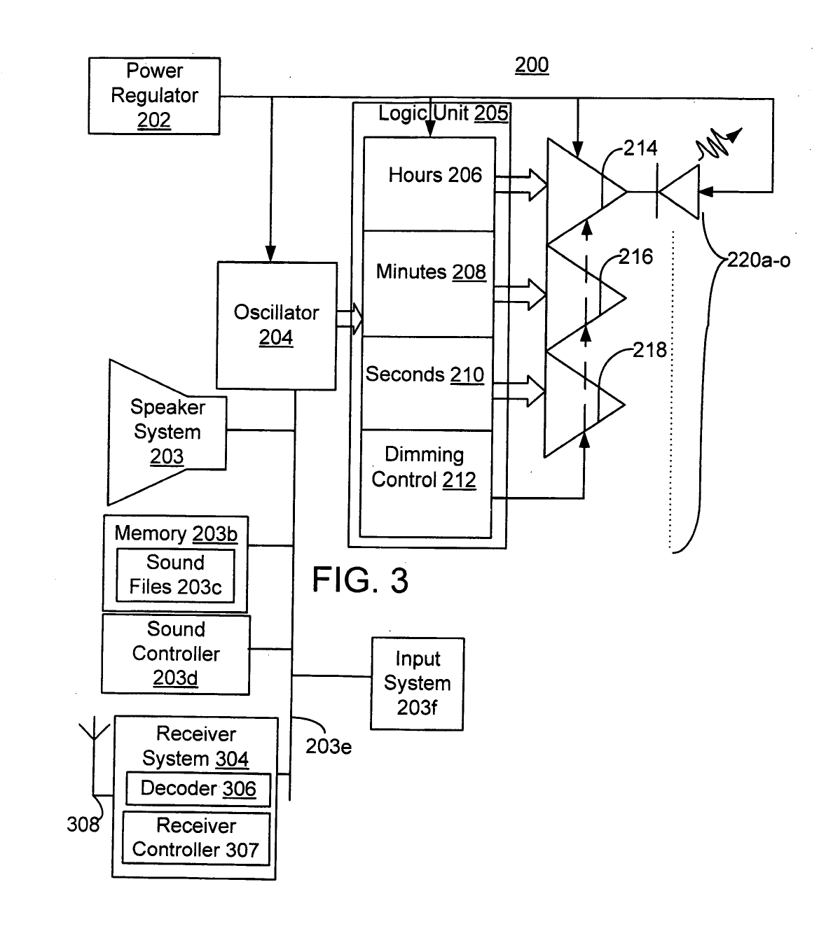

FIG. 3 shows a block diagram of an example of a circuit 300, which may be used in clock 100 instead of circuit 200. Circuit 300 includes power regulator 202, speaker system 203a, memory system 203b, sound files 203c, controller 203d, communications bus 203e, oscillator 204, hour controller 206, minute controller 208, second controller 210, dimming control 212, hour driver 214, minute driver 216, second driver 218, time indicators 220a-o, receiver 304, decoder 306, and receiver controller 307, and antenna 308. In other embodiments, 300 may not have all of the parts listed and/or may have other parts instead of, or in addition to, those listed.

Regulator 202, speaker system 203a, memory system 203b, sound files 203c, controller 203d, communications bus 203e, oscillator 204, hour controller 206, minute controller 208, second controller 210, dimming control 212, hour driver 214, minute driver 216, second driver 218, time indicators 220a-o, were described above in FIG. 2. Receiver 304 receives signals from an atomic clock and/or another clock that is expected to be more reliable than clock 100, and the signals received are used to reset clock 100 to ensure that clock 100 has the correct time. Decoder 306 decodes the signal received by receiver 304 and the decoded signals are used to synchronize clock 100 to the other clock that is expected to be more reliable than clock 100. Receiver controller 307 may set hour-indicators 102a-l, minute-indicators 104a-m, and/or second-indicators 106a-n to the time based on information relating to the current time that was extracted from the signal that was received and decoded. Antenna 308 receives the signals from the clock that is expected to be more reliable, and the signals are sent to receiver 304. For example, NIST radio station WWVB is located near Fort Collins, Colo. and broadcasts a time base and code throughout North America to synchronize consumer electronic products such as wall clocks, clock radios, and wristwatches. The signals from WWVB are just one example of a signal that may be received by receiver 304 to synchronize clock 100.

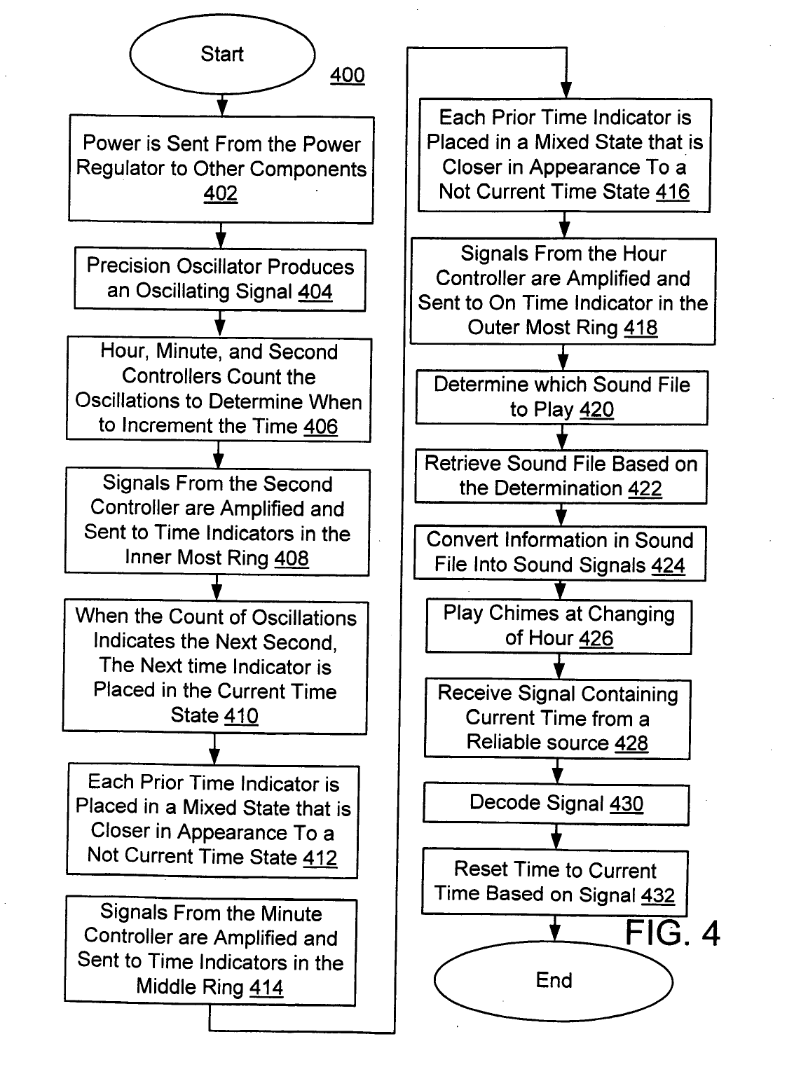

FIG. 4 shows a flowchart of an example of a method 400 of operating an embodiment of clock 100. In step 402, power is sent from power regulator 202 to the other components of clock 100. Step 402 is performed continually while clock 100 is on and is performed simultaneously with other steps of method 400. In step 404, oscillator 204 produces an oscillating signal. In step 406, hour controller 206, minute controller 208, and second controller 210 count the oscillations or receive a count of oscillations from oscillator 204 to determine when to increment the hour-indicators 102a-l, minute-indicators 104a-m, and second-indicators 106a-n.

In step 408, signals are sent from second controller 210 to second driver 214, where the signals are amplified, and then the amplified signal is sent from second driver 214 to second-indicators 106a-n. In step 410, when the count of oscillations indicates that a fifth of a second has passed, the next second-indicator is placed into the current time state. In step 412, the second-indicator that was in the current time state is placed into the mixed state that is closest in appearance to the current time state, and each of the second-indicators that formerly made up the trailing tail is placed into a state that is one level closer in appearance to the non-current time state. The second-indicator that was at the end of the tail in the prior second is changed from the mixed state that is closest to the non-current time state to being in the non-current time state, which creates the appearance of the tail advancing the distance of one second-indicator. For example, if the second-indicators are lights, each second-indicator that was part of the tail is dimmed to the brightness that its trailing neighbor had during the previous fifth of a second, and the last light, which was the dimmest light in the tail, is switched completely off.

In step 414, signals are sent from minute controller 212 to minute driver 216, where the signals are amplified, and then to minute-indicators 104a-m. In step 416, when the count of oscillations indicates that a minute has passed, the next minute-indicator is placed into the current time state. In step 418, the minute-indicator that was in the current time state is placed into the mixed state that is closest in appearance to the current time state, and each of the minute-indicators that formerly made up the trailing tail is placed into a state that is one level closer in appearance to the non-current time state. The minute-indicator that was at the end of the tail in the prior minute is changed from the mixed state that is closest to the non-current time state to being in the non-current time state, which creates the appearance of the tail advancing the distance of one minute-indicator. For example, if the minute-indicators are lights, each minute-indicator that was part of the tail is dimmed to the brightness that its trailing neighbor had during the previous second, and the last light, which was the dimmest light in the tail, is switched completely off.

In step 420, a determination is made as to which sound file to play and/or which portion of a sound file to play. The determination may be made by accessing a lookup table and/or a mathematical function that correlates names of sound files and/or identifiers of sections of sound files to different times of day. In step 422, the sound file or the portion of a sound file is retrieved based on the determination made in step 420. In step 424, the data or information in the sound file retrieved is converted into sound signals. In step 426, the sound signals are used to drive speaker system 203a, therein playing one of the chimes. In another embodiment, instead of storing sound files and implementing steps 420-426, the sound signals may be generated based on a mathematical function that uses the time of day and/or the day of the week and/or day of the year as input to compute a sound signal, which is the output of the function. Any of steps 420-426 may be performed before, after and/or during steps 404-418.

In step 428, signals are received from a reliable source of time that contains information related to the current time. In step 430, the signals are decoded into a form in which the signals may be compared to the current time on clock 100. In step 432, a determination is made as to whether the current time of clock 100 matches the time of the decoded signal. If they do not match, the time is set to the time corresponding to the decoded signal. Alternatively, no determination is made as to whether the current time on clock 100 matches the time associated with the decoded signal. Instead, the time is reset to the time associated with the decoded signal regardless of the current time of clock 100. If the time that was originally associated with clock 100 is already the same as the current time associated with the decoded signal, then there is no net change in the time that results. Any of steps 428-432 may be performed before, after and/or during steps 404-426.

In an embodiment, each of the steps of method 400 is a distinct step. In another embodiment, although depicted as distinct steps in FIG. 4, steps 402-432 may not be distinct steps. In other embodiments, method 400 may not have all of the above steps and/or may have other steps in addition to, or instead of, those listed above. The steps of method 400 may be performed in another order (e.g., any of the steps of method 400 may be performed in parallel). Subsets of the steps listed above as part of method 400 may be used to form their own method.

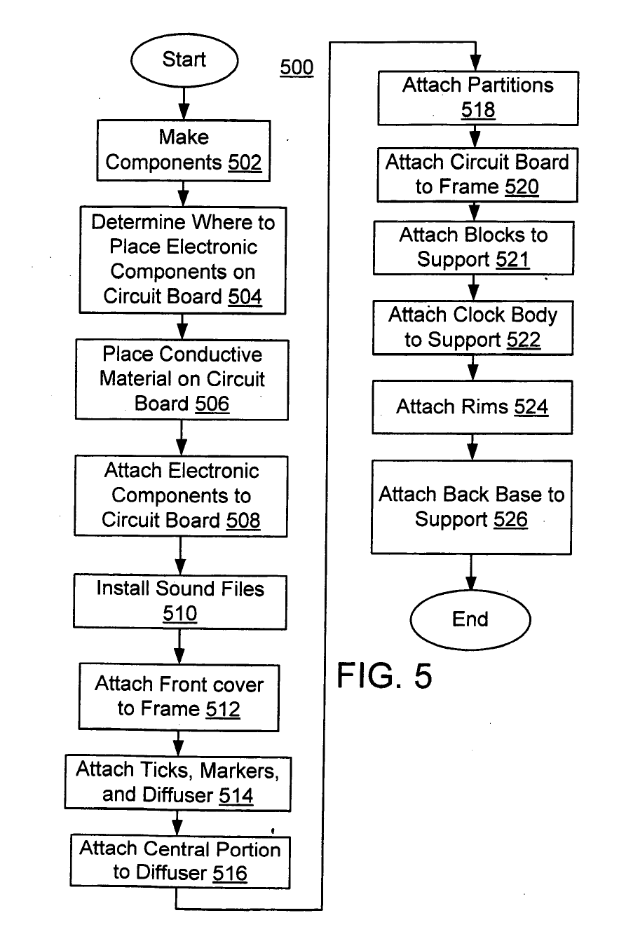

FIG. 5 shows a flowchart of an example of a method 500 of constructing clock 100. In step 502, the components of clock 100 are assembled or otherwise made, which may include assembling or making hour-indicator 102a, minute-indicator 104a, second-indicator 106a, support 152, having block body 154a, block rim 154b, screw 156, block body 158a, block rim 158b, clock body 160, clock rim 192, sliding base 164 (having main portion 164a, back edge portion 164b, front edge portion 164c), back base 166 (having tab 166a and tab 166b), central portion 170 (FIGS. 1A and B), frame 172, transparent cover 174, ticks 178a-l, light diffuser 180, partition 182a, partition 182b, partition 182c, circuit board 184, power regulator 202, speaker system 203a, memory system 203b, sound files 203c, controller 203d, communications bus 203e, oscillator 204, hour controller 206, minute controller 208, second controller 210, dimming control 212, hour driver 214, minute driver 216, second driver 218, time indicators 220a-o, receiver 304, and antenna 308.

In step 504, a determination is made of where to place the electrical components on circuit board 184. In step 506, conductive material and/or conductors are placed on circuit board 184 to communicatively couple the electronic components once the electronic components are placed in circuit board 184.

In step 508 the electronic component are attached to circuit board 184, thereby establishing the communicative coupling of the electronic components as determined by the conductors that were added to circuit board 184 in step 506. Thus, in performing step 508, power regulator may be communicatively coupled to all of the other active electrical components (active electrical components are the components that require a power source). Similarly, oscillator 204 may be communicatively coupled to speaker system 203a, sound controller 203d, input system 203f, hour controller 206, minute controller 208, and/or second controller 210. Sound controller 203d may be communicatively coupled to memory system 203b and/or speaker system 203a. Also, hour controller 206, minute controller 208, second controller 210, and dimming control 212 may be communicatively coupled to hour driver 214, minute driver 216, and second driver 218. Hour driver 214, minute driver 216, and second driver 218 may be communicatively coupled to time indicators 220a-o. Specifically, hour driver 214 may be communicatively coupled to hour-indicator 102a-l, minute driver 216 may be communicatively couple to minute-indicator 104a-m, and second driver 218 may be communicatively couple to second-indicators 106a-n. Dimming control 212 may also be coupled to hour driver 214, minute driver 216, and second driver 218 to control the overall brightness of the time indicators 220a-o. Additionally, receiver 304 may be communicatively coupled to antenna 308 and oscillator 204. Further, oscillator 204 may be communicatively coupled to speaker system 203a memory system 203b sound controller 203d, and/or input system 203f. Alternatively or additionally, speaker system 203a may be communicatively coupled to a bus, and the bus may establish the communicative coupling between each of the electronic components hooked to the bus. In other embodiments, the electronic components may be attached to the circuit board first and the conductive connections between the components may be established, and/or the conductive connections may be established while the electrical components are being attached to the circuit board.

In step 510, sound files 203c are installed in memory system 203b, and any programs for running sound controller 203d, hour controller 206, minute controller 208, second controller 210, and/or dimming control 212. Alternatively or additionally, sound controller 203d, hour controller 206, minute controller 208, second controller 210, and/or dimming control 212 may be otherwise configured for performing their tasks.

In step 512 front cover 174 is attached to frame 172, which is clock body 160. In step 514, markers 157a-t, ticks 159a-l, and diffuser 180 are attached to frame 172 and/or to transparent cover 174. If there is a transparent spacer between diffuser 180 and transparent cover 174, the transparent spacer may be attached to diffuser 180 or to transparent cover 174 prior to attaching diffuser 180 to frame 172.

In step 516, central portion 170 is attached to diffuser 180. In step 518, partitions 182a-c are attached to either circuit board 184 or diffuser 180 (as discussed above, in the embodiment illustrated in FIG. 1D, partition 182c is attached to circuit board 184, but in other embodiments partition 182c may be attached elsewhere). In step 520, circuit board 184 is attached to frame 172. In step 521, main body 154a and main body 158a are attached to support 152. In step 522, clock body 160 is attached to support 152.

In step 524, block rim 154b, block rim 158b, and optionally clock rim 192 are attached to main body 154a, main body 158a, and clock body 160, respectively. Alternatively, block rim 154b, block rim 158b, and/or clock rim 192 are attached to main body 154a, main body 158a, and/or clock body 160, respectively, prior to attaching main body 154a, main body 158a, and/or clock body 160 to support 152. For example, block rim 154b may be an integral part of main body 154a, and block rim 158b may be an integral part of main body 158a (e.g., carved from the same piece of wood).

In step 526, back base 166 is attached to support 152. In step 158, sliding base 164 is attached to back base 166. In an embodiment, each of the steps of method 500 is a distinct step. In another embodiment, although depicted as distinct steps in FIG. 5, step 502-526 may not be distinct steps. In other embodiments, method 500 may not have all of the above steps and/or may have other steps in addition to or instead of those listed above. The steps of method 500 may be performed in another order. Subsets of the steps listed above as part of method 500 may be used to form their own method.

Each embodiment disclosed herein may be used or otherwise combined with any of the other embodiments disclosed. Any element of any embodiment may be used in any embodiment. Any of the embodiments of the clock face, the interior of the clock, and/or circuitry of the clock may be included in a wristwatch or other timepiece.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
a first series of time indicators arranged in a first circle that indicates a current hour;
a second series of time indicators arranged in a second circle that is within the first circle that indicates a current minute; and
a third series of time indicators arranged in a third circle within the second circle that indicates a current second.

2. The system of claim 1, wherein the time indicators of the first series of time indicators, of the second series of time indicators, and of the third series of time indicators have at least two states, which include
a current time state, and
a non-current time state.

3. The system of claim 2, wherein
the time indicators of the second series of the time indicators has at least one mixed state, and
the third series of time indicators have a plurality of mixed states, and
the mixed states being states in which the time indicators have an appearance that is between that of the current time state and that of the non-current time state.

4. The system of claim 3, wherein
one of the time indicators of the second series corresponds to the current minute, which will be referred to as the current minute-indicator,
the current minute-indicator is in the current time state,
a first group of time indicators form a tail extending from the current minute-indicator in a counterclockwise direction and are in at least one mixed state, the tail extending from the current time indicator to a time indicator that is just after a position that is zero degrees from a 12 O'clock position,
one of the time indicators of the third series corresponds to the current second, which will be referred to as the current second-indicator,
the current second-indicator is in the current time state,
a second group of time indicators form a tail extending from the current second-indicator in a counterclockwise direction and are in mixed states, those time indicators closest in location to the current second-indicator have mixed states that are closest in appearance to the current second-indicator.

5. The system of claim 1, wherein the time indicators emit light.

6. The system of claim 5, further comprising one or more opaque partitions surrounding one or more of the time indicators.

7. The system of claim 5, further comprising a diffuser covering the time indicators of the second series and the time indicators of the third series on a side of the time indicators that is expected to be viewed by a viewer when reading the time.

8. The system of claim 1, wherein the time indicators are light emitting diodes.

9. The system of claim 1, wherein the system has a plano-concave lens having a flat side that is on a side facing a direction of view, the plano-concave lens being located in a central portion of the system.

10. The system of claim 1, further comprising
a surface, wherein the first series of time indicators, the second series of time indicators, and the third series of time indicators are attached to the surface;
a support that is parallel to the surface and that couples to the surface;
a stationary base attached to the support; and
a sliding base coupled to the system that slides in a direction perpendicular to the support.

11. The system of claim 1, further comprising:
a receiver for
receiving a signal containing information from which a current time is derived, and
setting a time associated with the system to the current time.

12. The system of claim 11, wherein the receiver includes a decoder for decoding the signal.

13. The system of claim 1, wherein the time indicators emit light, and the system further comprises a dimmer control for dimming an overall brightness of the system.

14. The system of claim 1, further comprising
an oscillator;
at least one programmable digital logic device for deriving a time from the oscillator; and
a set of one or more drivers for activating a set of time indicators that represent a current time.

15. The system of claim 1, further comprising;
one or more sound files;
a sound controller for accessing and processing information in the one or more sound files to produce a signal, based on a current time; and
a speaker for
receiving the signal, and
playing sounds corresponding to the sound files based on the signal.

16. The system of claim 1, wherein
the system is a clock,
the time indicators emit light,
the time indicators have at least two states, which include
a current time state, and
a non-current time state,
the time indicators of the second series of the time indicators has at least one mixed state, and
the third series of time indicators have a plurality of mixed states, and
the mixed states being states in which the time indicators have an appearance that is between that of the current time state and that of the non-current time state
one of the time indicators of the second series corresponds to the current minute, which will be referred to as the current minute-indicator,
the current minute-indicator is in the current time state,
a first group of time indicators form a tail extending from the current minute-indicator in a counterclockwise direction and are in at least one mixed state, the tail extending from the current time indicator to a time indicator that is just after a position that is zero degrees from a 12 O'clock position,
one of the time indicators of the third series corresponds to the current second, which will be referred to as the current second-indicator,
the current second-indicator is in the current time state,
a second group of time indicators form a tail extending from the current second-indicator in a counterclockwise direction and appear in mixed states, the time indicators that are closest in location to the current second-indicator appear in mixed states that are closest in appearance to the current second-indicator, and
the system further comprises:
a circuit board having the time indicators attached thereto,
one or more opaque partitions surrounding one or more of the time indicators,
a diffuser covering the time indicators of the second series and the time indicators of the third series on a side of the time indicators that is expected to be viewed by a viewer when reading the time,
ticks arranged to indicate positions of hours, time indicators of the first series being located below the ticks
a central portion that has a plano-convex lens having a flat side on the side that is viewed by a viewer and that is attached to the diffuser;
a transparent front cover located such that the diffuser and ticks are between the transparent front cover and the circuit board;
an octagonal frame supporting the diffuser, circuit board, and ticks;
a support couple to the octagonal frame;
a portion of at least one block being located between the circuit board and the support to hold the circuit board in place;
the at least one block having a portion, that can be seen by the viewer, having the words “It Is Now” and the words “Now Is Forever” thereon;
a stationary base attached to the support having two tabs;
a sliding base coupled to the system that slides in a direction perpendicular to the support and parallel to the stationary base, the sliding base being capable of sliding between the two tabs;
a receiver for
receiving a signal containing information from which a current time is derived, and
setting a time associated with the system to the current time based on the decoded signal,
wherein the receiver includes a decoder for decoding the signal;
one or more photo sensors for sensing an ambient light level;
a dimmer control for dimming an overall brightness of the system, wherein the clock includes at least one mode in the dimmer control that automatically dims the overall brightness in response to the one or more photo sensors sensing a change in the ambient light;
an oscillator;
one or more programmable digital logic devices for determining a time based on the oscillator; and
a set of one or more drivers that receive signals from the one or more programmable digital logic devices for the first series of time indicators, the second series of time indicators, and the third series of time indicators, and therein represent the current time,
a memory system having one or more machine readable media that store one or more sound files;
a sound controller for accessing and processing information in the one or more sound files to produce a signal based on the sound files and based on the current time; and
a speaker for
receiving the signal based on the sound files, and
playing sounds corresponding to the signal based on the sound files.

17. A method comprising displaying a current time by at least
displaying at least one or a first series of time indicators arranged in a first circle that indicate a current hour;
displaying a group of time indicators selected from a second series of time indicators arranged in a second circle that is within the first circle that indicates a current minute by at least placing a first time indicator at a current minute location in a current time state and displaying a set of time indicators in states that have an appearance that is a mix between the current time state and a non-current time state, wherein the set of time indicators form a tail extending in a counterclockwise direction from the first time indicator in the current minute state; and
displaying a group of time indicators selected from a third series of time indicators arranged in a third circle within the second circle that indicate a current second.

18. The method of claim 17, further comprising:
sending power from a power regulator to other components of a clock
sending signals to drivers to place a set of the time indicators in states representing a current time;
producing an oscillating signal;
counting oscillations of the oscillating signal;
after counting a first predetermined number of oscillations, which includes at least one oscillation, causing a change in the signals sent to the drivers that in turn causes a change in state of the group of time indicators associated with the current second by at least
causing a change in state of a time indicator associated with the current second from the non-current time state to the current time state,
causing a change in state in time indicators associated with a group of time indicators trailing the current second time indicator from appearing as a current mixed state to appearing as a mixed state that is closer in appearance to the non-current time state than the current mixed state, and
changing a time indicator in the group that is furthest from the current second-indicator from appearing as a mixed state to being in the non-current time state; and
after counting a second predetermined number of oscillations that is greater than the first predetermined number of oscillations, causing a change in the signals sent to the drivers that in turn causes a change in state of a group of time indicators associated with the current minute;
after counting a third predetermined number of oscillations, that is greater than the second predetermined number of oscillations, causing a change in the signals sent to the drivers that in turn causes
a change in state of a time indicator associated with the current hour from a non-current time state to a current time state, and
a change in state of a time indicator associated with a prior hour from the current time state to the non-current time state;
determining which sound file of a group of sound files to play based on a current time;
accessing at least a portion of one of the group of sound files based on the determining;
generating electrical signals based on the one of the group of sound files retrieved;
sending the electrical signals to a speaker system; and
converting the electrical signals via the speaker system into sound.

19. The method of claim 18, further comprising:
receiving signals from a source of time that is expected to be reliable, wherein the signals contain information related to the current time; and
setting the current time of the clock based on the information contained in the signals from the source of time.

20. A method comprising:
fixing a first series of time indicators in a first circle that indicates a current hour;
fixing a second series of time indicators in a second circle that is within the first circle that indicates a current minute; and
fixing a third series of time indicators in a third circle within the second circle that indicates a current second.

21. The method of claim 20, further comprising:
making
a support for a clock,
a first block,
a second block,
a frame,
a back base,
a sliding base,
a transparent cover,
a concave portion,
a transparent cover,
ticks,
a light diffuser,
one or more partitions, and
a circuit board;
assembling
a set of hour-indicators,
a set of minute-indicators,
a set of second-indicators,
a power regulator,
a speaker system including one or more speakers,
a memory system including one or more machine readable media,
one or more sound files,
a sound controller,
an oscillator,
an hour controller,
a minute controller,
a second controller,
a dimmer control,
one or more hour drivers,
one or more minute drivers,
one or more second drivers,
a receiver system including one or more receivers, and
an antenna system including one or more antenna;
determining where to place, on the circuit board, the
the set of hour-indicators,
the set of minute-indicators,
the set of second-indicators,
the power regulator,
the speaker system,
the memory system,
the sound controller,
the oscillator,
the hour controller,
the minute controller,
the second controller,
the dimmer control,
the one or more hour drivers,
the one or more minute drivers,
the one or more second driver,
the receiver system, and
the antenna system;
electrically connecting locations on the circuit board based on the determination;
attaching
the set of hour-indicators,
the set of minute-indicators,
the set of second-indicators,
the power regulator,
the speaker system,
the memory system,
the sound controller,
the oscillator,
the hour controller,
the minute controller,
the second controller,
the dimmer control,
the one or more hour drivers,
the one or more minute drivers,
the one or more second driver,
the receiver system, and
the antenna system
to the circuit board which includes at least
communicatively coupling the power regulator to all the other active electrical components,
communicatively coupling the oscillator to
the hour controller,
the minute controller,
the second controller, and
the sound controller,
communicatively coupling the sound controller to
the memory system, and
the speaker system,
communicatively coupling the hour controller to the one or more hour drivers,
communicatively coupling the minute controller to the one or more minute drivers,
communicatively coupling the second controller to the one or more second drivers,
communicatively coupling the dimmer control to
the one or more hour drivers,
the one or more minute drivers, and
the one or more second drivers,
communicatively coupling the receiver to the antenna and the oscillator,
placing the first series of time indicators in a first circle,
placing the second series of time indicators in a second circle that is within the first circle, and
placing the third series of time indicators in a third circle that is within the second circle,
installing sound files in the memory system,
configuring the sound controller to play specific sounds, based on the sound files, at specific times of day;
configuring the second controller to cause a group of the second-indicators to appear to be in a specific set of states based on a count associated with the oscillator;
configuring the minute controller to count oscillations from the oscillator and cause a group of the minute-indicators to appear to be in specific set of states based on the count;
configuring the hour controller to cause one hour-indicator to be in the current time state and all other hour-indicators to be in a non-current time state;
attaching the front cover to the frame;
attaching the ticks and the diffuser to the clock;
attaching the concave portion to the diffuser;
attaching the partitions to the circuit board surrounding each of time indicators;
attaching the first block and the second block to the support;
attaching the frame to the support between the first block and the second block;
attaching the back base to the support; and
attaching the sliding base to the support.
